(19) United States
(12) Patent Application Publication
(10) Pub. No.: US 2025/0087773 A1
(43) Pub. Date: Mar. 13, 2025

(54) MANAGEMENT APPARATUS OF BATTERY PACK, POWER STORAGE SYSTEM, MANAGEMENT METHOD OF BATTERY PACK, AND NON-TRANSITORY STORAGE MEDIUM

(71) Applicant: KABUSHIKI KAISHA TOSHIBA, Tokyo (JP)

(72) Inventors: Yumiko Sekiguchi, Kawasaki Kanagawa (JP); Keigo Hoshina, Yokohama Kanagawa (JP); Yasuyuki Hotta, Tokyo (JP)

(73) Assignee: KABUSHIKI KAISHA TOSHIBA, Tokyo (JP)

(21) Appl. No.: 18/650,933

(22) Filed: Apr. 30, 2024

(30) Foreign Application Priority Data
Sep. 8, 2023 (JP) 2023-146185

(51) Int. Cl. H01M 10/44; H01M 50/204; H01M 50/51; H02J 7/00

(52) U.S. Cl. CPC H01M 10/441; H01M 50/204; H01M 50/51; H02J 7/0048; H02J 7/007182; H01M 2300/0002

(57) ABSTRACT

In an embodiment, a management apparatus, managing a battery pack including a plurality of aqueous battery cells electrically connected in series, is provided. A control unit of the management apparatus performs constant-current charging of the battery pack until a voltage of the battery pack reaches a reference voltage value in response to at least an SOC difference value between a highest-SOC cell at a highest SOC and a lowest-SOC cell at a lowest SOC among the plurality of aqueous battery cells reaching a reference difference value or greater. The control unit performs constant-voltage charging of the battery pack at the reference voltage value in response to the voltage of the battery pack reaching the reference voltage value through the constant-current charging.

### CROSS-REFERENCE TO RELATED APPLICATION

This application is based upon and claims the benefit of priority from Japanese Patent Application No. 2023-146185, filed Sep. 8, 2023; the entire contents of which are incorporated herein by reference.

### FIELD

An embodiment relates to a management apparatus of a battery pack, a power storage system, a management meth od of a battery pack, and a non-transitory storage medium.

### BACKGROUND

A battery pack in which a plurality of aqueous battery cells are electrically connected in series may be used as a battery pack to be mounted in a battery-mounted apparatus such as a smartphone, a vehicle, a stationary power supply apparatus, a robot, and a drone. In such a battery pack in which a plurality of aqueous battery cells are electrically connected in series, each of the plurality of aqueous battery cells includes a positive electrode, a negative electrode, and an aqueous electrolyte, and an aqueous electrolytic solution obtained by dissolving electrolyte salt in an aqueous solvent, for example, is used as the aqueous electrolyte.

After repetitive charging and discharging of such a battery pack, a variation in state of charge (SOC) occurs among the plurality of aqueous battery cells configuring the battery pack. An increase in variation in SOC among the plurality of aqueous battery cells affects deterioration of the battery pack itself. In actuality, an increase in the variation in SOC tends to cause deterioration in the battery pack. It is thus required in the battery pack to correct the variation in SOC among the aqueous battery cells electrically connected in series.

A variation in SOC among a plurality of aqueous battery cells configuring a battery pack can be corrected by charging only some aqueous battery cells at a relatively low SOC or discharging only some aqueous battery cells at a relatively high SOC. In a power storage system including a battery pack, it is required to simplify the system configuration from the viewpoint of suppressing upsizing of the system. It is thus required to allow the variation in SOC among the plurality of aqueous battery cells to be corrected without providing a driving circuit, etc. for charging or discharging only some of the aqueous battery cells configuring the battery pack. That is, it is required to allow the variation in SOC among the plurality of aqueous battery cells in the battery pack to be corrected while realizing simplification of the system configuration.

### BRIEF DESCRIPTION OF THE DRAWINGS

FIG. 1 is a schematic view showing an example of a power storage system according to a first embodiment.

FIG. 2 is a schematic view showing an example of an aqueous battery cell forming a battery pack according to the first embodiment.

FIG. 3 is a flowchart schematically showing an example of a process of adjusting SOC among a plurality of aqueous battery cells of a battery pack, which is performed by a control unit, according to the first embodiment.

FIG. 4 is a flowchart schematically showing an example of a process of adjusting, by a control unit, SOC among a plurality of aqueous battery cells of a battery pack, according to a first modification.

FIG. 5 is a schematic view showing an example of a system including a stationary power supply apparatus according to an application example.

FIG. 6 is a schematic diagram showing a change in voltage of each of two aqueous battery cells during an SOC variation correction process being performed on a cell serial connection structure in verification related to the embodiment.

FIG. 7 is a schematic diagram showing a discharge curve of each of the two aqueous battery cells measured during discharging from the cell serial connection structure after the SOC variation correction process in the verification related to the embodiment.

### DETAILED DESCRIPTION

According to an embodiment, a management apparatus configured to manage a battery pack including a plurality of aqueous battery cells electrically connected in series, each of the plurality of aqueous battery cells including an aqueous electrolyte, a positive electrode, and a negative electrode, is provided, and the management apparatus includes a control unit. The control unit performs constant-current charging of the battery pack until a voltage of the battery pack reaches a reference voltage value in response to at least an SOC difference value between a highest-SOC cell at a highest SOC and a lowest-SOC cell at a lowest SOC among the plurality of aqueous battery cells reaching a reference difference value or greater. The control unit performs constant-voltage charging of the battery pack at the reference voltage value in response to the voltage of the battery pack reaching the reference voltage value through the constant-current charging.

The embodiment and the like will be explained below with reference to the drawings. Note that the measurements of physical quantities such as voltage and SOC were performed in an environment at 25° C. unless otherwise specified.

### First Embodiment

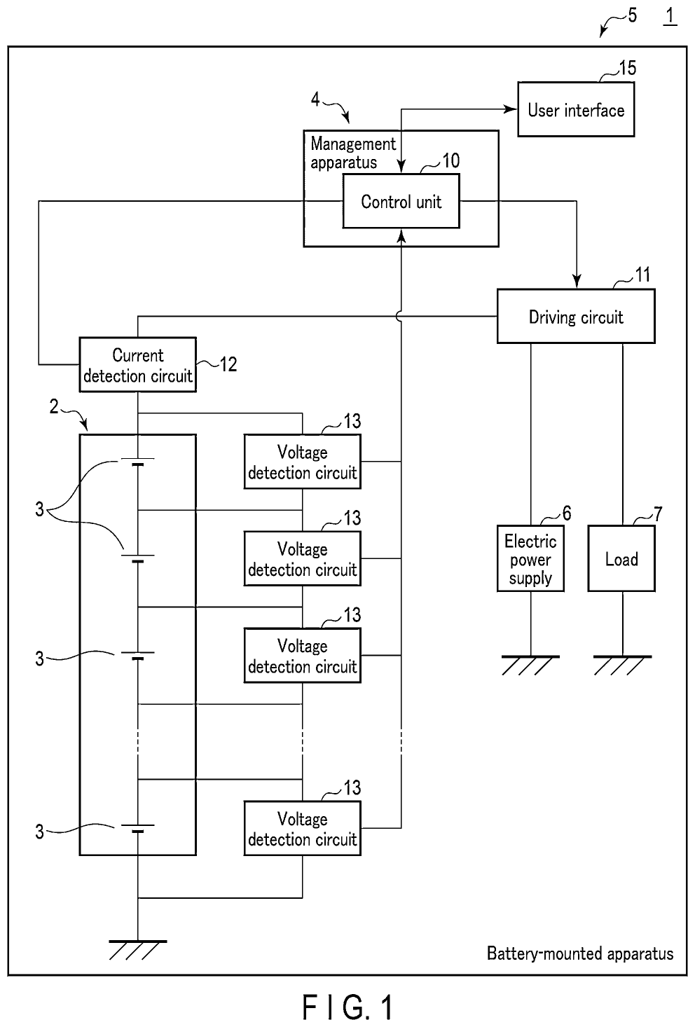

First, a first embodiment will be explained as an example of the embodiment. FIG. 1 is an example of a power storage system 1 according to the first embodiment. As shown in FIG. 1, the power storage system 1 includes a battery pack 2 and a management apparatus 4. In the example of FIG. 1, only a single battery pack 2 is provided in the power storage system 1. The battery pack 2 includes a plurality of aqueous battery cells 3, and the plurality of aqueous battery cells 3 are electrically connected in series in the battery pack 2. That is, in the battery pack 2, a cell serial connection structure in which a plurality of aqueous battery cells 3 are electrically connected in series is formed.

In the battery pack 2, a plurality of aqueous battery cells 3 are arranged in, for example, a housing (not illustrated). In the example of FIG. 1, the battery pack 2 is mounted in a battery-mounted apparatus 5. Examples of the battery-mounted apparatus 5 in which the battery pack 2 is mounted include a smart phone, a vehicle, a stationary power supply device, a robot, a drone, and examples of the vehicle that can be used as the battery-mounted apparatus 5 include an electric automobile, a plug-in hybrid electric automobile, and an electric motorcycle. Examples of the robot in which the battery pack 2 is mounted include a transfer robot such as an automated guided vehicle (AGV) used in factories, etc.

Each aqueous battery cell 3 is a single cell (single battery), and is, for example, a battery cell configuring a lithium ion secondary battery including an aqueous electrolyte as an electrolyte. Each aqueous battery cell 3 includes an electrode group, and the electrode group includes a positive electrode and a negative electrode. In the electrode group, a separator is interposed between the positive electrode and the negative electrode.

The separator is made of a material having electrical insulation properties, and electrically insulates the positive electrode from the negative electrode. The separator is formed to have, for example, a thickness from 1 μm or greater to 30 μm or smaller. Examples of the separator include, but are not limited to, a porous film and a nonwoven fabric, etc., which are made of a synthetic resin. Examples of the synthetic resin forming the porous film and the nonwoven fabric to be used as the separator are polyethylene (PE), polypropylene (PP), cellulose, and polyvinylidene fluoride (PVdF). In the separator, a non-conductive particle layer may be formed on at least one surface of the porous film or the nonwoven fabric, etc. Examples of the non-conductive particles include, but are not limited to, alumina, silica, zirconium, and solid electrolytic particles.

The positive electrode includes a positive electrode current collector such as a positive electrode current collecting foil, and a positive electrode active material-containing layer supported on a surface of the positive electrode current collector. The positive electrode current collector is made of a conductive metal. The positive electrode current collector is, but is not limited to, for example, aluminum, an aluminum alloy, stainless steel, or titanium, and has a thickness on the order of 10 μm to 30 μm. The positive electrode active material-containing layer includes a positive electrode active material, and may optionally contain a binder and an electro-conductive agent. Examples of the positive electrode active material include, but are not limited to, an oxide, a sulfide, and a polymer, which can occlude and release lithium ions. The positive electrode active material contains, for example, at least one selected from the group consisting of a lithium-manganese composite oxide, a lithium-nickel composite oxide, a lithium-cobalt-aluminum composite oxide, a lithium-nickel-cobalt-manganese composite oxide, a spinel lithium-manganese-nickel composite oxide, a lithium-manganese-cobalt composite oxide, a lithium-iron oxide, lithium fluorinated iron sulfate, a lithium-iron composite phosphate compound, and a lithium-manganese composite phosphate compound.

One or more types of carbonaceous materials, for example, are used as the electro-conductive agent. Examples of the carbonaceous materials to be used as the electro-conductive agent are acetylene black, Ketjenblack, graphite, and coke. A polymer resin, for example, is used as the binder. The binder contains, for example, at least one selected from the group consisting of polytetrafluoroethylene (PTFE), polyvinylidene e fluoride (PVdF), fluorine-based rubber, ethylene-butadiene rubber, polypropylene (PP), polyethylene (PE), carboxymethylcellulose (CMC), polyimide (PI), and polyacrylimide (PAI).

In the positive electrode active material-containing layer, the mixing ratio of the positive electrode active material is preferably from 70% by mass or higher to 95% by mass or lower, the mixing ratio of the electroconductive agent is preferably from 3% by mass or higher to 20% by mass or lower, and the mixing ratio of the binder is preferably from 2% by mass or higher to 10% by mass or lower. In formation of the positive electrode, a slurry is prepared by suspending the positive electrode active material, the electro-conductive agent, and the binder in an organic solvent, and the prepared slurry is applied onto one or both surfaces of the positive electrode current collector. Thereafter, the applied slurry is dried and rolled by a roll press or the like, thereby forming a positive electrode active material-containing layer supported on the one or both surfaces of the positive electrode current collector. In addition, the positive electrode current collector includes a positive electrode current collecting tab as a portion not supporting the positive electrode active material-containing layer.

The negative electrode includes a negative electrode current collector such as a negative electrode current collecting foil, and a negative electrode active material-containing layer supported on a surface of the negative electrode current collector. The negative electrode current collector is made of a conductive metal. The negative electrode current collector is, but is not limited to, for example, zinc, aluminum, an aluminum alloy, or copper, and has a thickness on the order of 10 μm to 30 μm. The negative electrode active material-containing layer may include a negative electrode active material, and may optionally contain a binder and an electro-conductive agent. Examples of the negative electrode active material include, but are not limited to, an active material which can occlude and release lithium ions, such as a metal oxide, a metal sulfide, a metal nitride, and a carbonaceous material. Examples of the metal oxide to be used as the negative electrode active material include a titanium-containing oxide. Examples of the titanium-containing oxide to be the negative electrode active material include, for example, a titanium oxide, a lithium titanium-containing composite oxide, niobium titanium-containing composite oxide, and a sodium niobium titanium-containing composite oxide. Examples of the electro-conductive agent and the binder of the negative electrode active material-containing layer include the same materials as those of the electro-conductive agent and the binder of the positive electrode active material-containing layer.

In the negative electrode active material-containing layer, the mixing ratio of the negative electrode active material is preferably from 70% by mass or higher to 95% by mass or lower, the mixing ratio of the electro-conductive agent is preferably from 3% by mass or higher to 20% by mass or lower, and the mixing ratio of the binder is preferably from 2% by mass or higher to 10% by mass or lower. In formation of the negative electrode, the negative electrode active material-containing layer supported on one or both surfaces of the negative electrode current collector is formed in the same manner as in the formation of the positive electrode. In addition, the negative electrode current collector includes a negative electrode current collecting tab as a portion not supporting the negative electrode active material-containing layer.

In one example, an electrode group has a wound structure in which a positive electrode, a negative electrode, and a separator are wound around a winding axis with a separator sandwiched between a positive electrode active material-containing layer and a negative electrode active material-containing layer. In another example, an electrode group has a stack structure in which a plurality of positive electrodes and a plurality of negative electrodes are stacked in an alternating manner, with a separator provided between the positive electrode and the negative electrode.

In each aqueous battery cell 3, the electrode group holds (is impregnated with) an aqueous electrolyte. As the aqueous electrolyte, an aqueous electrolytic solution obtained by dissolving electrolyte salt in an aqueous solvent, for example, is used. As the electrolyte salt to be dissolved in the aqueous solvent, at least one of, for example, lithium salt and sodium salt is used. Examples of the lithium salt to be dissolved in the aqueous solvent include lithium chloride (LiCl), lithium bromide (LiBr), lithium hydroxide (LiOH), lithium sulfate (Li₂SO₄), lithium nitrate (LiNO₃), lithium acetate (CH₃COOLi), lithium oxalate (Li₂C₂O₄), lithium carbonate (Li₂CO₃), lithium bis ((trifluoro methane sulfonyl)imide) (LiTFSI; LiN(SO₂CF₃)₂), lithium bis (fluorosulfonyl) imide (LiFSI; LiN(SO₂F)₂), and lithium bisoxalate borate (LiBOB; LiB[(OCO)₂]₂).

Examples of the sodium salt to be dissolved in the aqueous solvent include sodium chloride (NaCl), sodium sulfate (Na₂SO₄), sodium hydroxide (NaOH), sodium nitrate (NaNO₃), and sodium trifluoro methane sulfonyl amide (NaTFSA). The molar concentration of lithium ions in the aqueous electrolytic solution is, for example, 3 mol/L or higher. The molar concentration of lithium ions in the aqueous electrolytic solution is preferably 6 mol/L or higher, and more preferably 12 mol/L or higher.

A solution containing water is used as the aqueous solvent for dissolving the electrolyte salt. The aqueous solvent can be either pure water or a solvent mixture of water and an organic solvent. Examples of the organic solvent that is mixed with water include N-methyl-2-pyrrolidone (NMP). A small amount of zinc chloride (ZnCl₂), for example, may be added to the aqueous electrolytic solution.

Instead of the aqueous electrolytic solution, an aqueous gel electrolyte obtained by compositing the aqueous electrolytic solution and a polymer material may also be used as the aqueous electrolyte. Examples of the polymer material to be composited with the aqueous electrolytic solution are polyvinylidene fluoride (PVdF), polyacrylonitrile (PAN), and polyethylene oxide (PEO).

In each aqueous battery cell 3, the electrode group is housed inside a container member. As the container member, either a bag-shaped container made of a laminate film or a metal container can be used. Examples of the laminate film include a multilayer film including a plurality of resin layers and a metal layer arranged between the resin layers. The thickness of the laminate film is preferably 0.5 mm or smaller, and more preferably, 0.2 mm or smaller. The metal container is preferably formed of, for example, at least one metal selected from the group consisting of aluminum, zinc, titanium, and iron, or an alloy thereof. The wall thickness of the metal container is preferably 0.5 mm or smaller, and more preferably 0.2 mm or smaller.

In addition, each aqueous battery cell 3 includes a pair of electrode terminals. One of the electrode terminals is a positive electrode terminal electrically connected to the positive electrode current collecting tab, and the other electrode terminal is a negative electrode terminal electrically connected to the negative electrode current collecting tab. The electrode terminal may be an internal terminal formed inside the container member, or an external terminal formed on an outer surface of the container member. The electrode terminal is formed of an electro-conductive material, and is preferably formed of at least one metal selected from the group consisting of aluminum, zinc, titanium, and iron, or an alloy thereof.

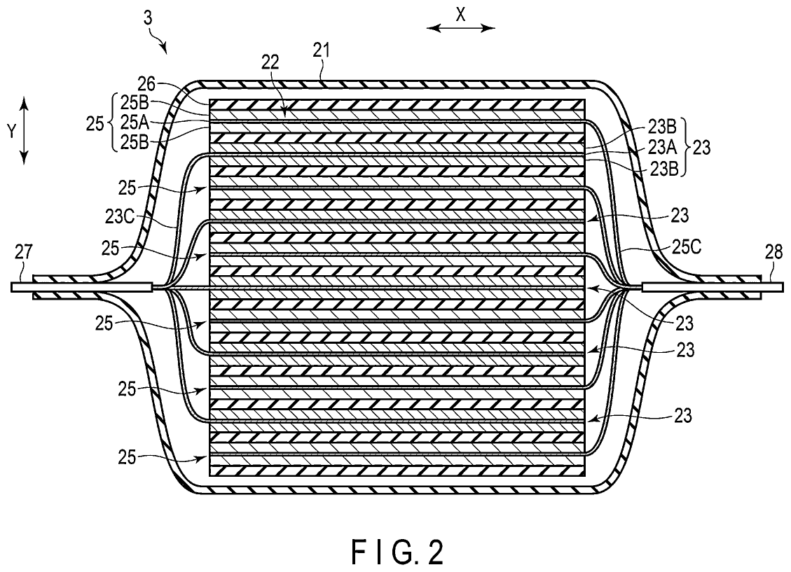

FIG. 2 shows an example of the aqueous battery cell 3. In the example of FIG. 2, in the aqueous battery cell 3, a lengthwise direction (a direction indicated by an arrow X), a widthwise direction (a direction orthogonal or substantially orthogonal to the paper surface of FIG. 2) intersecting substantially orthogonal to) the lengthwise direction, and a thickness direction (a direction indicated by an arrow Y) intersecting (orthogonal to or substantially orthogonal to) both the lengthwise direction and the widthwise direction are defined. The aqueous battery cell 3 includes a container member 21 and an electrode group 22. The container member 21 is the above-described laminate film. The electrode group 22 is housed inside the container member 21, and the electrode group 22 is impregnated with an aqueous electrolytic solution.

The electrode group 22 has a stack structure in which a plurality of positive electrodes 23 and a plurality of negative electrodes 25 are stacked in an alternating manner, with a separator 26 provided between the positive electrode 23 and the negative electrode 25. The stacking direction of the positive electrodes 23 and the negative electrodes 25 in the electrode group 22 matches or substantially matches the thickness direction of the aqueous battery cell 3. In each of the positive electrodes 23, a positive electrode active material-containing layer 23B is supported on both surfaces of a positive electrode current collector 23A, and in each of the negative electrodes 25, a negative electrode active material-containing layer 25B is supported on both surfaces of a negative electrode current collector 25A. In the electrode group 22, a positive electrode current collecting tab 23C, which is a portion not supporting the positive electrode active material-containing layer 23B on the positive electrode current collector 23A, is formed, and the positive electrode current collecting tab 23C protrudes toward one side in the lengthwise direction of the aqueous battery cell 3 with respect to the negative electrode 25 and the separator 26. In the electrode group 22, a negative electrode current collecting tab 25C, which is a portion not supporting the negative electrode active material-containing layer 25B on the negative electrode current collector 25A, is formed, and the negative electrode current collecting tab 25C protrudes to a side opposite to the side to which the positive electrode current collecting tab 23C protrudes, in the lengthwise direction of the aqueous battery cell 3, with respect to the positive electrode 23 and the separator 26.

Further, two openings are formed in the container member 21, and each of the openings is closed by heat-sealing, etc. of the resin layers of the laminate film. A positive electrode terminal 27 is connected to the positive electrode current collecting tab 23C, and the positive electrode terminal 27 is drawn out of the container member 21 from one of the two openings of the container member 21. A negative electrode terminal 28 is connected to the negative electrode current collecting tab 25C, and the negative electrode terminal 28 is drawn out of the container member 21 from the other one of the two openings of the container member 21 which is different from the opening out of which the positive electrode terminal 27 is drawn.

As shown in FIG. 1, an electric power supply 6 and a load 7 are provided in the power storage system 1. The electric power supply 6 can supply electric power to the battery pack 2, and the battery pack 2 is charged by supply of electric power from the electric power supply 6, etc. Electric power can be supplied to the load 7 from the battery pack 2, and the battery pack 2 is discharged by the supply of electric power to the load 7, etc. Examples of the electric power supply 6 include a storage battery different from the battery pack 2, an electric power generator, etc. Examples of the load 7 include an electric motor, a light, etc.

In an example, a motor generator may be provided in the power storage system 1. In this case, electric power can be supplied to the motor generator from the battery pack 2, and can also be supplied to the battery pack 2 from the motor generator. In other words, the motor generator functions as both an electric power supply and a load. In the example of FIG. 1, the electric power supply 6 and the load 7 are provided in the battery-mounted apparatus 5 in which the battery pack 2 is mounted. In one example, however, at least one of the electric power supply 6 and the load 7 may be provided outside the battery-mounted apparatus 5.

The management apparatus 4 manages the battery pack 2 by, for example, controlling charging and discharging of the battery pack 2, thereby managing the whole power storage system 1. The management apparatus 4 includes a control unit 10 serving as a controller. In the example of FIG. 1, the management apparatus 4 is mounted in the battery-mounted apparatus 5, and forms a processing device (computer) in the battery-mounted apparatus 5. The control unit 10 of the management apparatus 4 includes a processor and a non-transitory storage medium. The processor includes any one of a central processing unit (CPU), a graphics processing unit (GPU), an application-specific integrated circuit (ASIC), a microcomputer, a field-programmable gate array (FPGA), a digital signal processor (DSP), etc. In the non-transitory storage medium, an auxiliary storage device can be included, in addition to a main storage device such as a memory. Examples of the non-transitory storage medium include a magnetic disk, an optical disk (a CD-ROM, a CD-R, a DVD, etc.), a magneto-optical disk (MO, etc.), a semiconductor memory, etc.

The control unit 10 may include one or more processors and storage media. In the control unit 10, the processor performs processing by executing a program, etc. stored in the non-transitory storage medium, etc. In addition, a program executed by the processor of the control unit 10 may be stored in a computer (server) connected through a network, such as the Internet, or a server in a cloud environment, etc. In this case, the processor downloads the program via the network. The control unit 10 manages the battery pack 2 by executing a management program. Also, the control unit 10 adjusts an SOC of each of the plurality of aqueous battery cells 3 configuring the battery pack 2 by executing an SOC adjustment program included in the management program, as will be described later.

In addition, the management apparatus 4 may be provided outside the battery-mounted apparatus 5. In this case, the management apparatus 4 is, for example, a server outside the battery-mounted apparatus 5, and can communicate with a processing device (computer) mounted in the battery-mounted apparatus 5 via the network. In this case, too, the control unit 10 of the management apparatus 4 includes a processor and a non-transitory storage medium. In addition, processing of the control unit 10 of the management apparatus 4 may be performed by a processing device mounted in the battery-mounted apparatus 5 and a server (processing device) outside the battery-mounted apparatus 5 in cooperation. In this case, for example, the server, etc. outside the battery-mounted apparatus 5 is a master control device, and the processing device, etc. mounted in the battery-mounted apparatus 5 is a slave control device.

In another example, processing of the control unit 10 of the management apparatus 4 may be performed by a cloud server constructed in a cloud environment. Herein, the infrastructure of the cloud environment is constructed by a virtual processor such as a virtual CPU and a cloud memory. Thus, in a case where the cloud server functions as the control unit 10, processing is performed by the virtual processor, and data, etc. necessary for the processing is stored in the cloud memory. In addition, the processing of the control unit 10 may be performed by a processing device mounted in the battery-mounted apparatus 5 and the cloud server in cooperation. In this case, the processing device (computer) mounted in the battery-mounted apparatus 5 can communicate with the cloud server.

A driving circuit 11 is provided in the power storage system 1. The control unit 10 controls driving of the driving circuit 11, thereby controlling supply of electric power to the load 7 from the battery pack 2 as well as supply of electric power to the battery pack 2 from the electric power supply 6. Namely, the control unit 10 controls charging and discharging of the battery pack 2 by controlling the driving of the driving circuit 11. The driving circuit 11 includes a relay circuit that performs switching between output of electric power from the battery pack 2 and input of electric power to the battery pack 2. Further, the driving circuit 11 includes a conversion circuit, and the conversion circuit converts electric power from the electric power supply 6 into direct-current electric power to be supplied to the battery pack 2. The conversion circuit converts direct-current electric power from the battery pack 2 into electric power to be supplied to the load 7. The conversion circuit can include a voltage transformer circuit, a DC/AC conversion circuit, an AC/DC conversion circuit, etc. In the example of FIG. 1, the driving circuit 11 is mounted in the battery-mounted apparatus 5, but may be formed outside the battery-mounted apparatus 5.

The power storage system 1 also includes a current detection circuit 12, and a plurality of voltage detection circuits 13. The current detection circuit 12 detects a current flowing through the battery pack 2, that is, a current flowing through a cell serial connection structure configured by the plurality of aqueous battery cells 3. The voltage detection circuit 13 is provided for each of the plurality of aqueous battery cells 3 configuring the battery pack 2; in the power storage system 1, voltage detection circuits 13 of the same number as the plurality of aqueous battery cells 3 of the battery pack 2 are provided. Each voltage detection circuit 13 detects a voltage to be applied to a corresponding one of the aqueous battery cells 3. Consequently, the voltage of each of the aqueous battery cells 3 configuring the battery pack 2 can be detected by a corresponding one of the voltage detection circuits 13.

The power storage system 1 may also include a temperature sensor, in addition to the current detection circuit 12 and the voltage detection circuit 13. In this case, the temperature sensor detects a temperature of the battery pack 2. In one example, a temperature sensor detects a temperature at only a single location in the battery pack 2 or in an environment in which the battery pack 2 is arranged. The temperature detected at the single location is used as the temperature of the battery pack 2. In another example, a temperature sensor detects temperatures at multiple locations in the battery pack 2 or in an environment in which the battery pack 2 is arranged. An average value or a mean value of the temperatures detected at the multiple locations is used as the temperature of the battery pack 2.

The control unit 10 of the management apparatus 4 acquires detection results from the current detection circuit 12 and the voltage detection circuit 13. Thereafter, the control unit 10 controls charging and discharging of the battery pack 2 based on the current detection result at the current detection circuit 12 and the voltage detection result at the voltage detection circuit 13, thereby managing the battery pack 2. If the temperature sensor is provided, the control unit 10 manages the battery pack 2 based on the detection result at the temperature sensor, in addition to the detection results at the current detection circuit 12 and the voltage detection circuit 13.

In addition, in the power storage system 1 according to the example of FIG. 1, a user interface 15 is mounted in the battery-mounted apparatus 5. The user interface 15 functions as an operation device on which an operation, etc. is input by a user, etc. of the power storage system 1, as well as a notification device that notifies the user, etc. of the power storage system 1 of information. The user interface 15 includes an input means such as a button, a dial, or a touch panel as an operation device, and the control unit 10 performs processing based on an operation instruction, etc. input by the user interface 15. In addition, the control unit 10 makes a notification of information, etc. via the user interface 15. The user interface 15 makes the notification of the information through any one of output means such as screen display, sounds, etc. Note that the user interface 15 may be provided outside the battery-mounted apparatus 5.

For the battery pack 2, a state of charge (SOC) is defined as a parameter indicating a charging state. As for the voltage, a lower-limit voltage and an upper-limit voltage are defined in the battery pack 2. In the battery pack 2, a state in which the voltage during discharging or charging under predetermined conditions becomes the lower-limit voltage is defined as “0% SOC”, and a state in which the voltage during discharging or charging under predetermined conditions becomes the upper-limit voltage is defined as “100% SOC”. Also, in the battery pack 2, a charging capacity (charged electric charge amount) that brings the SOC from 0% to 100% through charging under predetermined conditions, or a discharging capacity (discharged electric charge amount) that brings the SOC from 100% to 0% through discharging under predetermined conditions, is defined as the battery capacity. A SOC of the battery pack 2 is the ratio of the remaining electric charge amount (remaining capacity) relative to 0% SOC to the battery capacity.

For each of the plurality of aqueous battery cells 3 configuring the battery pack 2, an SOC is defined as a parameter indicating a charging state. For the voltage of each aqueous battery cell 3, too, a lower-limit voltage and an upper-limit voltage are defined, similarly to the battery pack 2. For each of the aqueous battery cells 3, an SOC is defined based on the lower-limit voltage and the upper-limit voltage, similarly to the SOC of the battery pack 2.

The control unit 10 calculates a real-time SOC of each of the aqueous battery cells 3. In the non-transitory storage medium, etc. of the control unit 10, data showing a relationship between the SOC and an open-circuit voltage (OCV) of each aqueous battery cell 3 is stored. To calculate a real-time SOC of each aqueous battery cell 3, the control unit 10 acquires a real-time OCV of each aqueous battery cell 3. The OCV of each aqueous battery cell 3 can be detected by a corresponding one of the voltage detection circuits 13. The control unit 10 calculates a real-time SOC of each of the plurality of aqueous battery cells 3, using the OCV detected in real time, and the relationship between the SOC and the OCV stored in the non-transitory storage medium, etc.

The control unit 10 may calculate a real-time SOC of the battery pack 2. In this case, data showing a relationship between the SOC and the OCV of the battery pack 2 is stored in the non-transitory storage medium, etc. of the control unit 10. The control unit 10 acquires a real-time OCV of the battery pack 2, that is, a real-time OCV of the entirety of the cell serial connection structure configured by the plurality of aqueous battery cells 3. At this time, for example, each of the voltage detection circuits 13 detects an OCV of a corresponding one of the plurality of aqueous battery cells 3, and a total value of OCVs detected by the plurality of voltage detection circuits 13 is calculated as the OCV of the battery pack 2. The control unit 10 calculates a real-time SOC of the battery pack 2 using the real-time OCV and the relationship between the SOC and the OCV stored in the non-transitory storage medium, etc.

In the above-described example, the real-time SOC of the battery pack 2 and the real-time SOC of each aqueous battery cell 3 are calculated based on the OCV; however, the configuration is not limited thereto. The real-time SOC of the battery pack 2 and the real-time SOC of each aqueous battery cell 3 may be suitably calculated using a known method. In one example, a real-time electric charge amount of the battery pack 2 is calculated based on an electric charge amount at a predetermined time point, and based on a change over time of an electric current flowing through the battery pack 2 from a predetermined time point. For example, a real-time electric charge amount of the battery pack 2 is calculated by adding a time integrated value from a predetermined time point of an electric current flowing through the battery pack 2, to the electric charge amount at the predetermined time point. The change over time of the current flowing through the battery pack 2 can be detected by the current detection circuit 12. In the present example, the control unit 10 calculates a real-time SOC of the battery pack 2 based on a real-time electric charge amount.

In the power storage system 1, after repetitive charging and discharging of the battery pack 2, a variation in SOC occurs among the plurality of aqueous battery cells 3 electrically connected in series in the battery pack 2. If the variation in SOC among the plurality of aqueous battery cells 3 in the battery pack 2 increases to a certain level, the control unit 10 of the management apparatus 4 corrects the variation in SOC between the plurality of aqueous battery cells 3 in the battery pack 2. Thereby, the control unit 10 manages the battery pack 2 in such a manner that the variation in SOC among the plurality of aqueous battery cells 3 in the battery pack 2 does not exceed a reference level. That is, the SOC of each of the aqueous battery cells 3 is adjusted in such a manner that the variation in SOC among the plurality of aqueous battery cells 3 does not exceed a reference level.

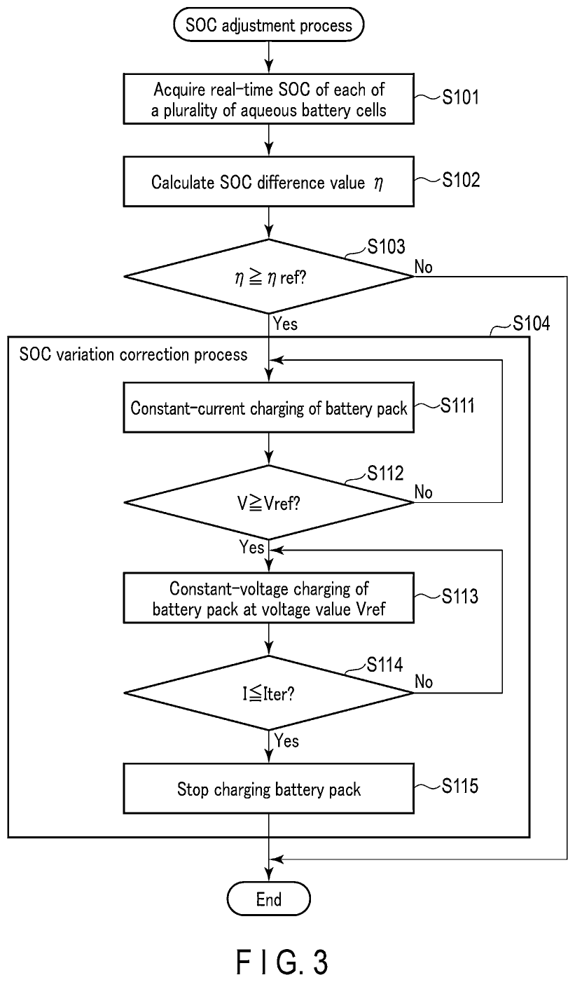

FIG. 3 shows an example of a process of adjusting, by the control unit 10, an SOC of each of the plurality of aqueous battery cells 3 of the battery pack 2. The process of the example of FIG. 3 is periodically performed after a time point of starting of use of the power storage system 1. The process of the example of FIG. 3 is performed by executing an SOC adjustment program included in the management program. Upon starting the example of FIG. 3, the control unit 10 acquires a real-time SOC of each of the plurality of aqueous battery cells 3 configuring the battery pack 2 (S101). At this time, for example, a real-time OCV of each of the plurality of aqueous battery cells 3 is acquired, and a real-time SOC of each aqueous battery cell 3 is calculated based on the real-time OCV and a relationship between the OCV and the SOC.

The control unit 10 calculates an SOC difference value η between a highest-SOC cell at the highest SOC and a lowest-SOC cell at the lowest SOC among the plurality of aqueous battery cells 3 (S102). The SOC difference value η is calculated by subtracting the SOC of the lowest-SOC cell from the SOC of the highest-SOC cell. The control unit 10 determines whether or not the calculated SOC difference value η is a reference difference value ηref or greater (S103). It is preferable that the reference difference value ηref be set in a range from 10% or greater to 20% or smaller.

If the SOC difference value η is the reference difference value ηref or greater (S103—Yes), the control unit 10 performs an SOC variation correction process of correcting a variation in SOC among the plurality of aqueous battery cells 3 configuring the battery pack 2 (S104). The SOC variation correction process is performed by executing an SOC variation correction program included in the SOC adjustment program. In the SOC variation correction process (S104), the control unit 10 performs constant-current charging of the battery pack 2 (the entirety of the cell serial connection structure configured by the plurality of aqueous battery cells 3) by controlling driving of the driving circuit 11 (S111). Thus, in response to at least the SOC difference value η between the highest-SOC cell and the lowest-SOC cell being the reference difference value ηref or greater, the constant-current charging of the battery pack 2 is performed. It is preferable that the charging rate in the constant-current charging be from 0.2 C or higher to 1 C or lower.

In the SOC variation correction process (S104), in a state in which constant-current charging of the battery pack 2 is being performed, the control unit 10 determines whether or not a voltage V of the battery pack 2 is the reference voltage value Vref or greater (S112). The voltage V of the battery pack 2 corresponds to the voltage applied to the entirety of the cell serial connection structure configured by the plurality of aqueous battery cells 3. If the voltage V of the battery pack 2 is lower than the reference voltage value Vref (S112—No), the process returns to S111, and the control unit 10 sequentially performs processing from S111. Thus, constant-current charging of the battery pack 2 is performed until the voltage V of the battery pack 2 reaches the reference voltage value Vref.

In the SOC variation correction process (S104), if a voltage V of the battery pack 2 is the reference voltage value Vref or greater (S112—Yes), the control unit 10 performs constant-voltage charging of the battery pack 2 (the entirety of the cell serial connection structure configured by the plurality of aqueous battery cells 3) at the reference voltage value Vref by controlling driving of the driving circuit 11 (S113). Thus, in response to the voltage V of the battery pack 2 reaching the reference voltage value Vref through the constant-current charging, constant-voltage charging of the battery pack 2 is performed at the reference voltage value Vref. In the constant-voltage charging, a current I input to the battery pack 2 is adjusted in a state in which the voltage V of the battery pack 2 is maintained at the reference voltage value Vref.

For each of the plurality of aqueous battery cells 3 configuring the battery pack 2, a charging voltage value is set as a voltage value in constant-voltage charging at the time of manufacturing. In the specification of each aqueous battery cell 3, the charging voltage value is defined as a voltage value at the time of constant-voltage charging. Also, a total value Vα of the charging voltage values of the plurality of aqueous battery cells 3 configuring the battery pack 2 is defined. In one example, the reference voltage value Vref is set to be higher than a total value Vα of charging voltage values of the plurality of aqueous battery cells 3. In this case, it is preferable that the reference voltage value Vref be set to 1.1 times or less of the total value Vα, and it is more preferable that the reference voltage value Vref be set to 1.05 times or less of the total value Vα.

Also, an OCV Vβ1 of the battery pack 2 at 90% SOC and an OCV Vβ2 of the battery pack 2 at 100% SOC are defined. The OCV Vβ2 is higher than the OCV Vβ1. In one example, the reference voltage value Vref is set to be higher than the value of the OCV Vβ1 at 90% SOC. In this case, it is preferable that the reference voltage value Vref be set to be higher than the value of the OCV Vβ2 at 100% SOC. Moreover, it is preferable that the reference voltage value Vref be set to 1.1 times or less of the value of the OCV Vβ2 at 100% SOC, and it is more preferable that the reference voltage value Vref be set to 1.05 times or less of the value of the OCV Vβ2.

Furthermore, a total value Vγ1 of OCVs of the plurality of aqueous battery cells 3 at 90% SOC and a total value Vγ2 of OCVs of the plurality of aqueous battery cells 3 at 100% SOC are defined. The total value Vγ2 is higher than the total value Vγ1. In one example, the reference voltage value Vref is set to be higher than the total value Vγ1 of OCVs at 90% SOC state. In this case, it is preferable that the reference voltage value Vref be set to be higher than the total value Vγ2 of OCVs at 100% SOC. Also, it is preferable that the reference voltage value Vref be set to 1.1 times or less of a total value Vγ2 of OCVs at 100% SOC, and it is more preferable that the reference voltage value Vref be set to 1.05 times or less of the total value Vγ2 of the OCVs.

In the SOC variation correction process (S104), in a state in which constant-voltage charging of the battery pack 2 at the reference voltage value Vref is being performed, the control unit 10 determines whether or not the current I input to the battery pack 2 is a termination current value Iter or smaller (S114). If the current I of the battery pack 2 is larger than the termination current value Iter (S114-No), the process returns to S113, and the control unit 10 sequentially performs processing from S113. Thus, constant-voltage charging of the battery pack 2 is performed until the current I of the battery pack 2 drops to the termination current value Iter.

If the current I of the battery pack 2 is the termination current value Iter or smaller (S114—Yes), the control unit 10 stops charging of the battery pack 2 by controlling driving of the driving circuit 11 (S115). Thereby, the SOC variation correction process (S104) is terminated, and the process of the example of FIG. 3 is terminated. The termination current value Iter is set to, for example, 0.1 C or smaller. Also, if the SOC difference value η is smaller than the reference difference value ηref at S103 (S103—No), the control unit 10 does not perform the SOC variation correction process (S104). Thus, the process of the example of FIG. 3 is terminated without performing the SOC variation correction process (S104). By suitably repeating the process of the example of FIG. 3, the variation in SOC of the battery pack 2 is corrected.

In one example, instead of the process at S114, the control unit 10 determines whether or not an elapsed time ε from a time point of starting of constant-voltage charging of the battery pack 2 at the reference voltage value Vref is a termination time εter or longer. If the elapsed time ε from the time point of starting of the constant-voltage charging is shorter than the termination time εter, the process returns to S113, and the control unit 10 continues constant-voltage charging of the battery pack 2 at the reference voltage value Vref. On the other hand, if the elapsed time ε from the time point of starting of the constant-voltage charging is the termination time εter or longer, the control unit 10 stops the charging of the battery pack 2.

In another example, in a state in which the constant-voltage charging of the battery pack 2 at the reference voltage value Vref is being performed, the control unit 10 calculates an SOC difference value η between a highest-SOC cell at the highest SOC and a lowest-SOC cell at the lowest SOC among a plurality of aqueous battery cells 3. At this time, the SOC difference value η is calculated in a manner similar to the process at S102. Thereafter, the control unit 10 determines whether or not the calculated SOC difference value η is a termination difference value ηter or smaller. If the SOC difference value η is larger than the termination difference value ηter, the process returns to S113, and the control unit 10 continues constant-voltage charging of the battery pack 2 at the reference voltage value Vref. On the other hand, if the SOC difference value η is the termination difference value ηter or smaller, the control unit 10 stops the charging of the battery pack 2. The termination difference value ηter is set to be smaller than a reference difference value ηref used for the determination at S103, and is set in a range from 0% or more to 5% or less.

As described above, in the present embodiment, in response to at least an SOC difference value η between a highest-SOC cell and a lowest-SOC cell being a reference difference value ηref or greater, constant-current charging of the battery pack 2 is performed until a voltage V of the battery pack 2 reaches a reference voltage value Vref. In response to the voltage V of the battery pack 2 reaching the reference voltage value Vref through the constant-current charging, constant-voltage charging of the battery pack 2 is performed at the reference voltage value Vref. Therefore, a variation in SOC among the plurality of aqueous battery cells 3 is corrected by performing constant-voltage charging at the reference voltage value Vref after the constant-current charging.

Since the SOC variation correction is performed as described above, if the SOC of the battery pack 2 increases to a certain level, that is, if the overall voltage of the battery pack 2 increases to a certain level, electrolysis of water easily occurs in an aqueous battery cell 3 having a relatively high SOC among the plurality of aqueous battery cells 3, even if charging is continued. Thus, if the overall voltage of the battery pack 2 increases to a certain level, in an aqueous battery cell 3 with a relatively high SOC, an increase in voltage is suppressed even if charging is continued, suppressing a rise in the SOC.

On the other hand, even if the overall voltage of the battery pack 2 increases to a certain level, in an aqueous battery cell 3 with a relatively low SOC among the plurality of aqueous battery cells 3, a battery reaction easily advances if charging is continued. Thus, even if the overall voltage of the battery pack 2 increases to a certain level, in the aqueous battery cell 3 with a relatively low SOC, the voltage is increased by continuing charging, causing a rise in the SOC. Therefore, in a battery pack 2 in which a plurality of aqueous battery cells 3 are electrically connected in series, the variation in SOC among the plurality of aqueous battery cells 3 can be appropriately corrected by performing constant-voltage charging of the battery pack 2 at the reference voltage value Vref after performing constant-current charging of the battery pack 2.

In the present embodiment, since a variation in SOC among the plurality of aqueous battery cells 3 occurs as described above, charging of only some aqueous battery cells 3 with a relatively low SOC and discharging of only some aqueous battery cells with a relatively high SOC are not performed in the SOC variation correction. It is thus possible to correct the variation in SOC among the plurality of aqueous battery cells 3 without providing a driving circuit, etc. for charging or discharging only some (part) of the aqueous battery cells 3 configuring the battery pack 2. Therefore, it is possible to correct the variation in SOC among the plurality of aqueous battery cells 3 of the battery pack 2, while realizing simplification of the system configuration of the power storage system 1. With the simplification of the system configuration of the power storage system 1, upsizing of the power storage system 1 is suppressed.

In the present embodiment, in response to at least an SOC difference value η between a highest-SOC cell and a lowest-SOC cell being a reference difference value ηref or greater, constant-current charging is started, and a process of correcting a variation in SOC among the plurality of aqueous battery cells 3 is started. It is thus possible, by setting the reference difference value ηref to a suitable value, to effectively prevent the variation in SOC among the plurality of aqueous battery cells 3 from increasing beyond a reference level in the battery pack 2. By setting the reference difference value ηref to 20% or less, it is possible to effectively prevent the variation in SOC among the plurality of aqueous battery cells 3 from increasing to an extent that would affect deterioration of the battery pack 2 itself.

In the present embodiment, by setting the reference difference value ηref to a suitable value, it is possible to effectively prevent the SOC variation correction process from being performed at a frequency that interferes with the operation of the battery pack 2. By setting the reference difference value ηref to, for example, 10% or more, it is possible to appropriately perform the process of correcting the variation in SOC among the plurality of aqueous battery cells 3 without interfering with the operation of the battery pack 2. In the present embodiment, by setting, for example, the reference difference value ηref in a range from 10% or more to 20% or less, it is possible to effectively prevent the variation in SOC among the plurality of aqueous battery cells 3 from increasing beyond a reference level, and to correct the variation in SOC among the plurality of aqueous battery cells 3 without interfering with the operation of the battery pack 2.

In the present embodiment, in one example, the reference voltage value Vref is set to be higher than a total value Vα of charging voltage values of the plurality of aqueous battery cells 3; in another example, the reference voltage value Vref is set to be higher than a value of the OCV Vβ1 of the battery pack 2 at 90% SOC; and in yet another example, the reference voltage value Vref is set to be higher than a total value Vγ1 of OCVs of the plurality of aqueous battery cells 3 at 90% SOC. By setting the reference voltage value Vref as in the above-described examples, the variation in SOC among the plurality of aqueous battery cells 3 is appropriately corrected by the above-described SOC variation correction process.

If the reference voltage value Vref is set to be higher than a value of the OCV Vβ1 of the battery pack 2 at 90% SOC, the variation in SOC among the plurality of aqueous battery cells 3 can be further appropriately corrected by setting the reference voltage value Vref to be higher than a value of the OCV Vβ2 of the battery pack 2 at 100% SOC. If the reference voltage value Vref is set to be higher than a total value Vγ1 of OCVs of the plurality of aqueous battery cells 3 at 90% SOC, the variation in SOC among the plurality of aqueous battery cells 3 can be further appropriately corrected by setting the reference voltage value Vref to be higher than a total value Vγ2 of OCVs of the plurality of aqueous battery cells 3 at 100% SOC.

In the present embodiment, in one example, the reference voltage value Vref is set to 1.1 times or less of a total value Vα of charging voltage values of the plurality of aqueous battery cells 3; in another example, the reference voltage value Vref is set to 1.1 times or less of a value of the OCV Vβ2 at 100% SOC state; and in yet another example, the reference voltage value Vref is set to 1.1 times or less of a total value Vγ2 of OCVs at 100% SOC. By setting the reference voltage value Vref as in the above-described examples, it is possible, in the charging of the battery pack 2 in the SOC variation correction process described above, to effectively prevent overcharging of the aqueous battery cells 3, and to reduce the amount of gas generated by the electrolysis of water in the aqueous battery cells 3.

Also, if the reference voltage value Vref is set to 1.1 times or less of the total value Vα, it is possible to further effectively prevent overcharging of the aqueous battery cells 3 and to further reduce the gas generated by the electrolysis of water by setting the reference voltage value Vref to 1.05 times or less of the total value Vα. Similarly, if the reference voltage value Vref is set to 1.1 times or less of a value of the OCV Vβ2, it is possible to further effectively prevent overcharging of the aqueous battery cells 3 and to further reduce the gas generated by the electrolysis of water by setting the reference voltage value Vref to 1.05 times or less of the value of the OCV Vβ2. Also, if the reference voltage value Vref is set to 1.1 times or less of the total value Vγ2, it is possible to further effectively prevent overcharging of the aqueous battery cells 3 and to further reduce the gas generated by the electrolysis of water by setting the reference voltage value Vref to 1.05 times or less of the total value Vγ2.

### Modification

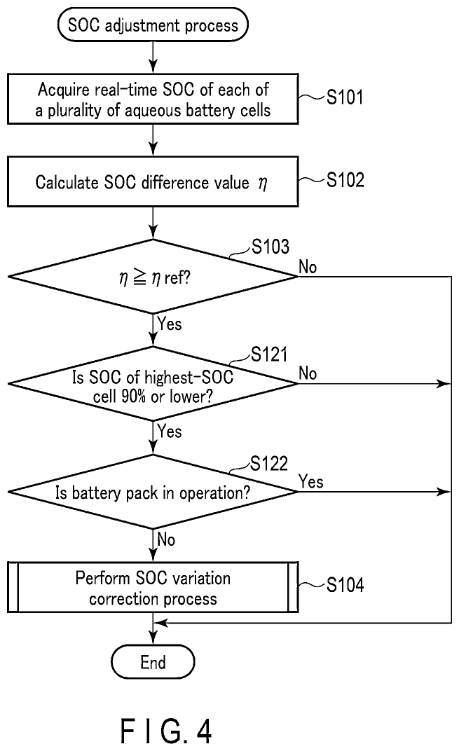

FIG. 4 shows an example of a process of adjusting, by a control unit 10, an SOC of each of a plurality of aqueous battery cells 3 of a battery pack 2, according to a first modification. The process of the example shown in FIG. 4, which is periodically performed at or after a time point of starting of use of the power storage system 1, is performed by executing an SOC adjustment program included in the management program, similarly to the process of the example of FIG. 3. In the process of the example of FIG. 4, the processing from S101 to S103 is performed, similarly to the process of the example of FIG. 3.

In the present modification, if an SOC difference value η between the highest-SOC cell and the lowest-SOC cell is a reference difference value ηref or greater at S103 (S103—Yes), the control unit 10 determines whether or not the SOC of the highest-SOC cell is 90% or less (S121). If the SOC of the highest-SOC cell is higher than 90% (S121—No), the process of the example of FIG. 4 is terminated without performing an SOC variation correction process (S104). On the other hand, if the SOC of the highest-SOC cell is 90% or less (S121—Yes), the control unit 10 determines whether or not the battery pack 2 is in operation (S122). At this time, determination is performed as to whether or not the battery pack 2 is in operation based on, for example, whether or not charging or discharging of the battery pack 2 is performed.

If the battery pack 2 is in operation (S122—Yes), that is, if the battery pack 2 is being charged or discharged, the process of the example of FIG. 4 is terminated, without performing the SOC variation correction process (S104). On the other hand, if the battery pack 2 is not in operation (S122—No), that is, in a state in which charging and discharging of the battery pack 2 are stopped, the control unit 10 performs a process of correcting a variation in SOC among the plurality of aqueous battery cells 3 (S104). The SOC variation correction process is performed in a manner similar to the above-described embodiment, etc. Therefore, in the SOC variation correction process, constant-current charging of the battery pack 2 is performed until the voltage V of the battery pack 2 reaches a reference voltage value Vref, and in response to the voltage V of the battery pack 2 reaching the reference voltage value Vref through the constant-current charging, constant-voltage charging of the battery pack 2 is performed at the reference voltage value Vref.

In the present modification, advantages and effects similar to those of the above-described embodiment, etc. are produced. Therefore, in the present modification, too, it is possible to correct the variation in SOC among the plurality of aqueous battery cells 3 of the battery pack 2, while realizing simplification of the system configuration of the power storage system 1.

In the present modification, in response to the SOC of the highest-SOC cell being 90% or less, in addition to the SOC difference value η between the highest-SOC cell and the lowest-SOC cell being the reference difference value ηref or greater, an SOC variation correction process is performed. Thus, in a state in which there are no aqueous battery cells 3 at an SOC higher than 90%, the SOC variation correction process is started, and constant-current charging is started. Since the SOC variation correction is started in a state in which there are no aqueous battery cells 3 at an SOC higher than 90%, the variation in SOC among the plurality of aqueous battery cells 3 is further appropriately corrected by the above-described SOC variation correction process.

Also, in the present modification, during the operation of the battery pack 2, that is, in a state in which the battery pack 2 is being charged or discharged, the SOC variation correction process is not started. Thus, it is possible to further effectively prevent the operation of the battery pack 2 from being interfered with by the SOC variation correction process.

In another modification, only one of the determination at S121 or S122 may be performed in the process of the example of FIG. 4. In this case, too, a process of correcting a variation in SOC among the plurality of aqueous battery cells 3 is performed, similarly to the above-described embodiment, etc. It is thus possible to correct a variation in SOC among the plurality of aqueous battery cells 3 of the battery pack 2, while realizing simplification of the system configuration of the power storage system 1.

In one example, a plurality of battery packs 2 are provided in the power storage system 1. In this case, in the power storage system 1, at least one of a pack series connection structure in which a plurality of battery packs 2 are electrically connected in series and a pack parallel connection structure in which a plurality of battery packs 2 are electrically connected in parallel is formed. In the present modification, each of a plurality of battery packs 2 includes a plurality of aqueous battery cells 3. In each of the plurality of battery packs 2, the plurality of aqueous battery cells 3 are electrically connected in series, and a cell serial connection structure in which the plurality of aqueous battery cells 3 are electrically connected in series is formed.

In the present modification, an SOC of each of the plurality of aqueous battery cells 3 is adjusted in each of the plurality of battery packs 2, similarly to the above-described embodiment. Therefore, in each of the plurality of battery packs 2, a variation in SOC among the plurality of aqueous battery cells 3 is corrected, similarly to the above-described embodiment, etc. According to the present modification, advantages and effects similar to those of the above-described embodiment are produced.

### Application Example

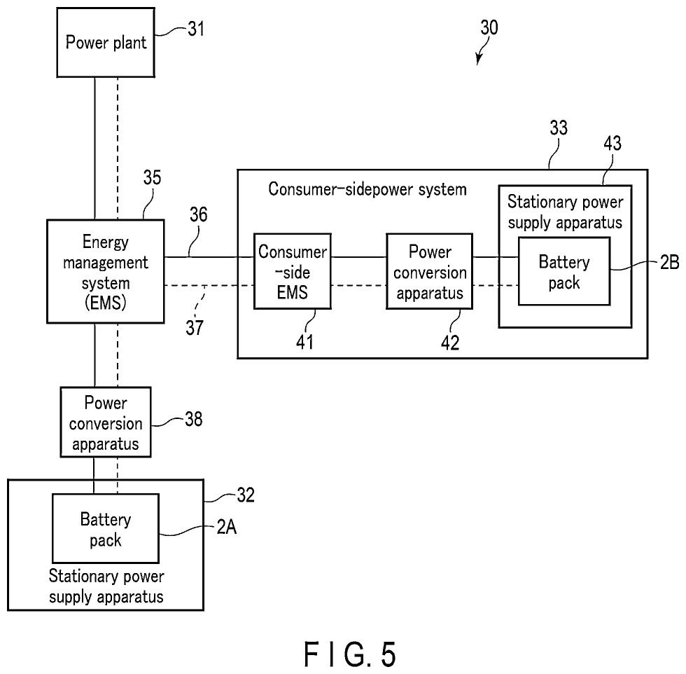

As an example in which the above-described battery pack 2 is mounted in the battery-mounted apparatus 5, an application example in which the battery pack 2 is mounted in a stationary power supply apparatus will be explained below. FIG. 5 shows an example of a system including a stationary power supply apparatus according to the application example. In the example of FIG. 5, a battery pack 2A is mounted in a stationary power supply apparatus 32, and a battery pack 2B is mounted in a stationary power supply apparatus 43. The stationary power supply apparatuses 32 and 43 are used in a system 30. The system 30 includes a power plant 31, the stationary power supply apparatus 32, a consumer-side power system 33, and an energy management system (EMS) 35. In addition, a power network 36 and a communication network 37 are formed in the system 30, and a power plant 31, a stationary power supply apparatus 32, a consumer-side power system 33, and an EMS 35 are connected through the power network 36 and the communication network 37. The EMS 35 performs control for stabilizing the whole system 30 by utilizing the power network 36 and the communication network 37.

The power plant 31 generates large-capacity electric power by using a fuel source such as thermal power or atomic power. The power plant 31 supplies the electric power through the power network 36, etc. The battery pack 2A of the stationary power supply apparatus 32 can store the electric power, etc. supplied from the power plant 31. Also, the stationary power supply apparatus 32 can supply the electric power stored in the battery pack 2A through the power network 36, etc. A power conversion apparatus 38 is provided in the system 30. The power conversion apparatus 38 includes a converter, an inverter, a transformer, and the like. Accordingly, the power conversion apparatus 38 can perform, for example, conversion between a direct current and an alternate current, conversion between alternate currents having different frequencies, and voltage transformation (step-up and step-down). Thus, the power conversion apparatus 38 can convert the electric power from the power plant 31 into electric power that can be stored in the battery pack 2A. In the example of FIG. 5, the power conversion apparatus 38 functions in the same manner as the above-described driving circuit 11, in charging, discharging, etc. of the battery pack 2A.

The consumer-side power system 33 includes, for example, a power system for a factory, a power system for a building, and a household power system. The consumer-side power system 33 includes a consumer-side EMS 41, a power conversion apparatus 42, and the stationary power supply apparatus 43. The consumer-side EMS 41 performs control for stabilizing the consumer-side power system 33.

The electric power from the power plant 31 and the electric power from the battery pack 2A are supplied to the consumer-side power system 33 through the power network 36. The battery pack 2B of the stationary power supply apparatus 43 can store the electric power supplied to the consumer-side power system 33. Also, the power conversion apparatus 42 includes a converter, an inverter, and a voltage transformer, etc., similarly to the power conversion apparatus 38. Accordingly, the power conversion apparatus 42 can perform, for example, conversion between a direct current and an alternate current, conversion between alternate currents having frequencies, different and voltage transformation (step-up and step-down). Accordingly, the power conversion apparatus 42 can convert the electric power supplied to the consumer-side power system 33 into electric power that can be stored in the battery pack 2B. In the example of FIG. 5, the power conversion apparatus 42 functions in the same manner as the above-described driving circuit 11, in charging, discharging, or the like of the battery pack 2B.

Note that the electric power stored in the battery pack 2B can be used to, for example, charge a vehicle such as an electric automobile. A natural energy source can also be provided in the system 30. In this case, the natural energy source generates electric power by natural energy such as wind power and sunlight. The electric power is also supplied from the natural energy source through the power network 36, as well as from the power plant 31.

In the example of FIG. 5, a current detection circuit 12 and a voltage detection circuit 13 described above are mounted in each of the stationary power supply apparatuses 32 and 43. Thus, the current of each of the battery packs 2A and 2B is detected, and the voltage of each of the plurality of aqueous battery cells 3 is detected in each of the battery packs 2A and 2B. A temperature sensor may be mounted in each of the stationary power supply apparatuses 32 and 43. In this case, a temperature of each of the battery packs 2A and 2B is detected.

In addition, one or more of the EMS 35, a computer separate from the EMS 35, a cloud server, and the like function as the above-described management apparatus 4 for managing the battery pack 2A. In the battery pack 2A, a process of adjusting an SOC of each of the plurality of aqueous battery cells 3 is performed, and a process of correcting a variation in SOC among the plurality of aqueous battery cells 3 is performed, similarly to the above-described embodiment, etc. Also, one or more of the EMS 35, the consumer-side EMS 41, a computer separate from the EMS 35 and the consumer-side EMS 41, a cloud server, and the like function as the above-described management apparatus 4 for managing the battery pack 2B. In the battery pack 2B, a process of adjusting an SOC of each of the plurality of aqueous battery cells 3 is performed, and a process of correcting a variation in SOC among the plurality of aqueous battery cells 3 is performed, similarly to the above-described embodiment, etc.

### Verification Related to Embodiment

A verification related to the above-described embodiment was conducted. The conducted verification will be explained below. In this verification, an aqueous battery cell (single cell) in which an electrode group having a stack structure was housed inside a laminate film was formed in the same manner as the aqueous battery cell 3 of the example of FIG. 2. In this aqueous battery cell, a positive electrode and a negative electrode were formed as follows.

For the positive electrode, a titanium sheet was used as a positive-electrode current collector. As a positive-electrode active material, particles of LiNiCoMnO₂ (Ni:Co:Mn=5:2:3), which is a type of a lithium-nickel-cobalt-manganese composite oxide, were prepared. In addition, acetylene black (AB), which is a carbonaceous material, was used as an electro-conductive agent, and polyvinylidene fluoride (PVdF), which is a type of a polymer resin, was used as a binder. The lithium-nickel-cobalt-manganese composite oxide, the acetylene black, and the polyvinylidene fluoride were suspended at blending ratios of 90% by mass, 5% by mass, and 5% by mass, respectively, in a solvent of N-methylpyrrolidone (NMP), which is a type of an organic solvent, and thereby a slurry was prepared. Thereafter, the prepared slurry was applied onto both surfaces of the titanium sheet as a positive-electrode current collector. At this time, the slurry was applied onto the positive-electrode current collector excluding a portion that would become a positive-electrode current collecting tab.

After the applied slurry was dried, the slurry was rolled by a roll press or the like, thereby forming positive-electrode active material-containing layers on both surfaces of the titanium sheet. Thereafter, by drying the positive-electrode current collector and the positive-electrode active material-containing layers formed on both surfaces of the positive-electrode current collector, a positive electrode was formed.

For the negative electrode, a zinc sheet was used as a negative-electrode current collector. As a negative-electrode active material, particles of Li₄TiₛO₁₂, which is a type of lithium-titanium containing composite oxide, were prepared. In addition, acetylene black (AB), which is a carbonaceous material, was used as an electro-conductive agent, and polyvinylidene fluoride (PVdF), which is a type of a polymer resin, was used as a binder. The lithium-titanium-containing composite oxide, the acetylene black, and the polyvinylidene fluoride were suspended at blending ratios of 90% by mass, 5% by mass, and 5% by mass, respectively, in a solvent of N-methylpyrrolidone (NMP), which is a type of organic solvent, and thereby a slurry was prepared. Thereafter, the prepared slurry was applied onto both surfaces of the zinc sheet, which is a negative-electrode current collector. At this time, the slurry was applied onto the negative-electrode current collector excluding a portion that would become a negative-electrode current collecting tab.

After the applied slurry was dried, the slurry was rolled by a roll press or the like, thereby forming negative-electrode active material-containing layers on both surfaces of the zinc sheet. Thereafter, a negative electrode was formed by drying the negative-electrode current collector and the negative-electrode active material-containing layers formed on both surfaces of the negative-electrode current collector.

The electrode group was formed to have a stack structure by stacking four negative electrodes and three positive electrodes in an alternating manner. In the electrode group, a separator was interposed between the positive electrode and the negative electrode. As the separator, a porous film of polyethylene, which is a type of a synthetic resin film, was used. The thickness of the porous film was 15 μm. In this separator, alumina particle layers, which are non-conductive particle layers, were formed on both surfaces of the porous film. The thickness of the alumina particle layer was 3 μm. Subsequently, the formed electrode group was housed inside a container member formed of a laminate film. A metal layer of the laminate film was made of aluminum.

In addition, the electrode group was impregnated with an aqueous electrolytic solution as an aqueous electrolyte. As this aqueous electrolytic solution, an electrolytic solution made of an aqueous solution prepared by dissolving lithium chloride (LiCl) and lithium hydroxide (LiOH) as lithium salt was used. In the electrolytic solution, the concentration of lithium chloride was set at 12 mol/L, and the concentration of lithium hydroxide was set at 1 mol/L. Also, in the electrolytic solution, N-methyl-2-pyrrolidone (NMP), which is an organic solvent, was added at 10% by mass, and zinc chloride (ZnCl₂) was added at 1% by mass to the above-described aqueous solution prepared by dissolving lithium salt. Thereafter, the aqueous electrolytic solution prepared as described above was injected into the container member from a liquid injection port, and the container member was liquid-tightly sealed by closing the liquid injection port.

In the verification, two aqueous battery cells (C1 and C2) described above were formed. For each of the aqueous battery cells Cl and C2, the charging voltage value, which is a voltage value at the time of constant-voltage charging, was set to 2.5 V. In the verification, the SOC of each of the two aqueous battery cells C1 and C2 was adjusted, to make the SOCs of the aqueous battery cells C1 and C2 differ by 20%. At this time, the SOC of the aqueous battery cell C2 is made higher than the SOC of the aqueous battery cell C1 by 20%, and the voltage of the aqueous battery cell C2 is made higher than the voltage of the aqueous battery cell C1. By electrically connecting the aqueous battery cells C1 and C2 in series in a state in which the SOCs of the aqueous battery cells C1 and C2 differed by 20%, a cell serial connection structure was formed.

A SOC variation correction process was performed on the cell serial connection structure configured by the aqueous battery cells C1 and C2, similarly to the above-described embodiment, etc. At this time, a voltage value corresponding to the reference voltage value Vref was set to 5.08 V, and constant-current charging of the cell serial connection structure at 0.5 C was performed until the voltage of the cell serial connection structure became 5.08 V. In response to the voltage of the cell serial connection structure reaching 5.08 V through the constant-current charging, constant-voltage charging of the cell serial connection structure was performed at 5.08 V.

The voltage 5.08 V corresponding to the reference voltage value Vref was set to be higher than the total value 5.0 V of the charging voltages of the aqueous battery cells C1 and C2. Also, the voltage 5.08 V was set to be 1.05 times or less of the total value of the charging voltages of the aqueous battery cells C1 and C2, that is, 5.25 V or smaller. In the verification, constant-voltage charging of the cell serial connection structure at 5.08 V was performed until the current input to the cell serial connection structure dropped to 0.1 C. That is, in response to the current input to the cell serial connection structure having dropped to 0.1 C, charging of the cell serial connection structure was stopped, and the SOC variation correction process was terminated.

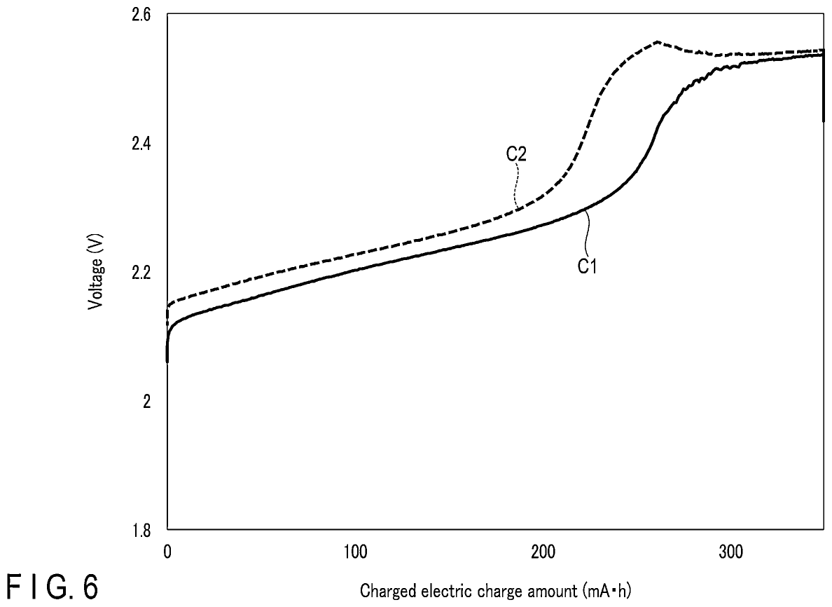

FIG. 6 shows a change in voltage of each of two aqueous battery cells C1 and C2 during an SOC variation correction process being performed on a cell serial connection structure in verification. In FIG. 6, a charged electric charge amount based on a time point of starting of an SOC variation correction process is shown on the abscissa axis, and a voltage is shown on the ordinate axis. Also, in FIG. 6, a change in voltage of the aqueous battery cell C1 is shown by the solid line, and a change in voltage of the aqueous battery cell C2 is shown by the dashed line.

As shown in FIG. 6, in the aqueous battery cell C2 with a higher SOC, after the cell serial connection structure was charged to a certain level in the SOC variation correction process, an increase in the voltage was suppressed even by continuing charging, thus suppressing a rise in the SOC. On the other hand, in the aqueous battery cell C1 with a lower SOC, even after the cell serial connection structure was charged to a certain level in the SOC variation correction process, the voltage increased by continuing charging, causing a rise in the SOC. Through the SOC variation correction process, a variation in SOC among the aqueous battery cells C1 and C2 was corrected.

In the verification, after the variation in SOC among the aqueous battery cells C1 and C2 was corrected, as described above, the cell serial connection structures of the aqueous battery cells C1 and C2 were discharged. At this time, the cell serial connection structures were discharged at a discharge rate of 1 C. During the constant-current discharging, the voltage of each of the aqueous battery cells C1 and C2 was detected, and a change over time of the voltage of each of the aqueous battery cells C1 and C2 was measured. Thereby, a discharge curve showing a change in voltage in discharging after the SOC variation correction process was measured for each of the aqueous battery cells C1 and C2.

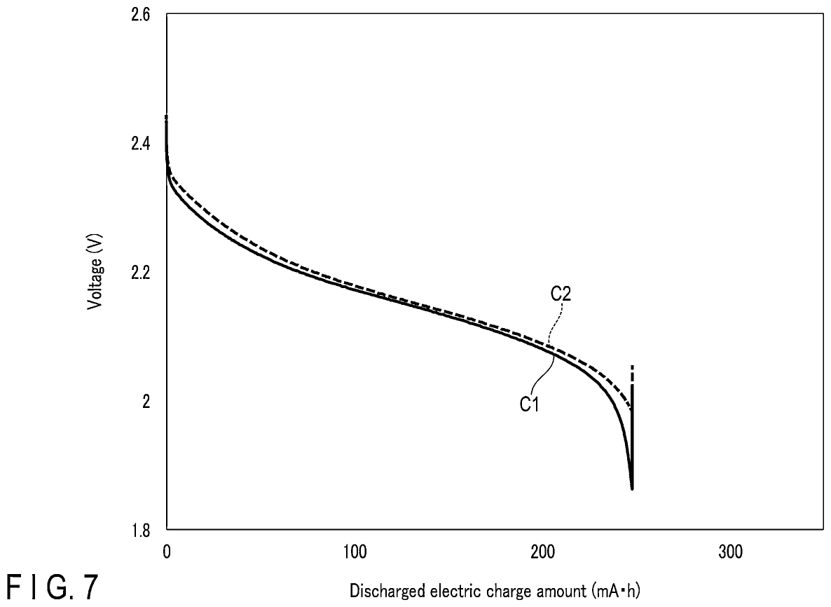

FIG. 7 shows a discharge curve of each of the two aqueous battery cells C1 and C2 measured during discharging from the cell serial connection structure after the SOC variation correction process in the verification. In FIG. 7, a discharged electric charge amount with reference to a time point of starting of discharging is shown on the abscissa axis, and a voltage is shown on the ordinate axis. Also, in FIG. 7, a change in voltage of the aqueous battery cell C1 is shown by the solid line, and a change in voltage of the aqueous battery cell C2 is shown by the dashed line. As shown in FIG. 7, as a result of the discharging from the cell serial connection structures after the SOC variation correction process, there was little deviation between the voltages shown by the discharge curves of the aqueous battery cells C1 and C2.

Through the above-described verification, it has been demonstrated that, by correcting the variation in SOC among the plurality of aqueous battery cells electrically connected in series in a manner similar to the above-described embodiment, a deviation between the voltages among the plurality of aqueous battery cells can be appropriately corrected, and the variation in SOC among the plurality of aqueous battery cells can be appropriately corrected.

According to at least one embodiment or example described above, in a battery pack in which a plurality of aqueous battery cells are electrically connected in series, in response to at least an SOC difference value between a highest-SOC cell at a highest SOC and a lowest-SOC cell at a lowest SOC among a plurality of aqueous battery cells reaching a reference difference value or greater, constant-current charging of the battery pack is performed until the voltage of the battery pack reaches a reference voltage value. In response to the voltage of the battery pack reaching the reference voltage value through the constant-current charging, constant-voltage charging of the battery pack is performed at the reference voltage value. It is thereby possible to provide a management apparatus of a battery pack, a power storage system, a management method of a battery pack, and a management program of a battery pack capable of correcting a variation in SOC among the plurality of aqueous battery cells electrically connected in series in a battery pack while realizing simplification of the system configuration.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A management apparatus configured to manage a battery pack including a plurality of aqueous battery cells electrically connected in series, each of the plurality of aqueous battery cells including an aqueous electrolyte, a positive electrode, and a negative electrode, the management apparatus comprising a control unit configured to:
perform constant-current charging of the battery pack until a voltage of the battery pack reaches a reference voltage value in response to at least a state of charge (SOC) difference value between a highest-SOC cell at a highest SOC and a lowest-SOC cell at a lowest SOC among the plurality of aqueous battery cells configuring the battery pack reaching a reference difference value or greater; and
perform constant-voltage charging of the battery pack at the reference voltage value in response to the voltage of the battery pack reaching the reference voltage value through the constant-current charging.

2. The management apparatus according to claim 1, wherein the reference difference value is set in a range from 10% or more to 20% or less.

3. The management apparatus according to claim 1, wherein
a charging voltage value is defined as a voltage value in constant-voltage charging for each of the plurality of aqueous battery cells configuring the battery pack, and
the reference voltage value of the battery pack is set to be higher than a total value of the charging voltage values of the plurality of aqueous battery cells.

4. The management apparatus according to claim 1, wherein
the reference voltage value of the battery pack is set to be higher than a value of an open-circuit voltage (OCV) of the battery pack at a 90% SOC.

5. The management apparatus according to claim 1, wherein
the reference voltage value of the battery pack is set to be higher than a total value of OCVs of the plurality of aqueous battery cells at a 90% SOC.

6. The management apparatus according to claim 1, wherein
the control unit performs the constant-current charging of the battery pack until the voltage of the battery pack reaches the reference voltage value in response to the SOC of the highest-SOC cell being 90% or less, in addition to the SOC difference value being the reference difference value or greater.

7. A power storage system, comprising:
the management apparatus according to claim 1; and
the battery pack including the plurality of aqueous battery cells electrically connected in series and managed by the management apparatus.

8. The power storage system according to claim 7, further comprising:
a battery-mounted apparatus in which the battery pack is mounted.

9. A management method for managing a battery pack including a plurality of aqueous battery cells electrically connected in series, each of the plurality of aqueous battery cells including an aqueous electrolyte, a positive electrode, and a negative electrode, the method comprising:
performing constant-current charging of the battery pack until a voltage of the battery pack reaches a reference voltage value in response to at least an SOC difference value between a highest-SOC cell at a highest SOC and a lowest-SOC cell at a lowest SOC among the plurality of aqueous battery cells configuring the battery pack reaching a reference difference value or greater; and
performing constant-voltage charging of the battery pack at the reference voltage value in response to the voltage of the battery pack reaching the reference voltage value through the constant-current charging.

10. A non-transitory storage medium storing thereon a management program for managing a battery pack including a plurality of aqueous battery cells electrically connected in series, each of the plurality of aqueous battery cells including an aqueous electrolyte, a positive electrode, and a negative electrode, the management program causing a computer to implement:
performing constant-current charging of the battery pack until a voltage of the battery pack reaches a reference voltage value in response to at least a state of charge (SOC) difference value between a highest-SOC cell at a highest SOC and a lowest-SOC cell at a lowest SOC among the plurality of aqueous battery cells configuring the battery pack reaching a reference difference value or greater; and
performing constant-voltage charging of the battery pack at the reference voltage value in response to the voltage of the battery pack reaching the reference voltage value through the constant-current charging.
